(19) United States
(12) Patent Application Publication
(10) Pub. No.: US 2006/0067872 A1
(43) Pub. Date: Mar. 30, 2006

(54) Method of preparing catalyst base for manufacturing carbon nanotubes and method of manufacturing carbon nanotubes employing the same

(76) Inventors: Ha-Jin Kim, Suwon-si (KR); In-Taek Han, Seoul (KR)

Correspondence Address: Robert E. Bushnell, Suite 300, 1522 K Street, N.W., Washington, DC, 20005, US

(21) Appl. No.: 11/171,247

(22) Filed: Jul. 1, 2005

(30) Foreign Application Priority Data
Jul. 2, 2004 (KR) 10-2004-0051523

(51) Int. Cl. D01F 9/12; B01J 21/18

(52) U.S. Cl. 423/447.3; 502/182; 502/185

(57) ABSTRACT

A novel method of forming a catalyst base that can control the growth density of carbon nanotubes and increase the uniformity of the carbon nanotubes and a method of synthesizing carbon nanotubes employing the method of forming the catalyst base are provided. A precursor paste containing a catalytic metal precursor, a solid and a vehicle is applied on a substrate; and the catalytic metal precursor of the precursor paste applied on the substrate is reduced to form catalytic metal particles. According to the present invention, the growth density of carbon nanotubes can be easily controlled and carbon nanotubes with smaller and uniform diameters can be formed.

### CLAIM OF PRIORITY

This application claims the priority of Korean Patent Application No. 10-2004-0051523, filed on Jul. 2, 2004, in the Korean Intellectual Property Office, the disclosure of which is incorporated herein in its entirety by reference.

### BACKGROUND OF THE INVENTION

1. Field of the Invention

The present invention relates to a method of preparing a catalyst base for manufacturing carbon nanotubes and a method of manufacturing carbon nanotubes employing the same.

2. Description of the Related Art

A carbon nanotube is a cylindrical material having a diameter of several nano-meters and a very large aspect ratio of about 10 to 1,000. In the carbon nanotube, the carbons are generally arranged in a hexagonal honeycomb pattern. One carbon atom bonds to three adjacent carbon atoms. The carbon nanotube may be a conductor or a semiconductor according to its structure. The carbon nanotube as a conductor has high electroconductivity. Also, the carbon nanotube has superior mechanical strength, Young's modulus of tera, and high heat conductivity. The carbon nanotube having these properties can advantageously be used in various technical fields such as an emitter of a field emission display (FED), a transistor, a catalyst support of a fuel cell, a supercapacitor, and the like.

Examples of a method of manufacturing the carbon nanotubes include arc discharging, laser deposition, plasma enhanced chemical vapor deposition (PECVD), chemical vapor deposition (CVD), vapor phase growth, electrolysis, and the like. The vapor phase growth is suitable for synthesizing the carbon nanotubes in bulk form since it synthesizes the carbon nanotubes in a vapor phase by directly supplying a reaction gas and a catalytic metal into a reactor without using a substrate. The arc discharge and the laser deposition have relatively low yields of carbon nanotubes. It is difficult to control the diameter and the length of the carbon nanotube using the arc discharge and the laser deposition. Further, in the arc discharge and the laser deposition, lumps of amorphous carbon besides the carbon nanotubes are produced in a large amount, and thus a complicated purifying process must be followed.

CVD methods, such as thermal chemical vapor deposition, low pressure chemical vapor deposition and PECVD are generally used to form carbon nanotubes on a substrate. In the PECVD, the carbon nanotubes can be synthesized at low temperatures by activating gas with plasma. In the PECVD, it is relatively easy to control the diameter, the length, the density, etc. of the carbon nanotubes.

In the case of chemical vapor deposition methods, a catalyst base, on which carbon nanotubes grow, is first formed on a substrate so that the carbon nanotubes are formed with a uniform density on the substrate.

As used herein, the term “catalyst base” refers to a catalyst itself, on which carbon nanotubes grow, or any material containing such a catalyst.

For example, a transition metal thin film deposited by e-beam evaporation or sputtering was used as the catalyst base in U.S. Pat. No. 6,350,488. However, when growing carbon nanotubes based on the catalyst base, it is difficult to control the growth density of carbon nanotubes, thereby lowering the uniformity of the produced carbon nanotubes. Moreover, expensive vacuum equipment must be used to form the catalyst base. It is also difficult to apply the catalyst base to a substrate of a large area.

In addition, transition metal particles supported on a porous support was used as the catalyst base in U.S. Pat. No. 6,401,526. However, when using such a catalyst base, patterning and control of the growth density of carbon nanotubes are difficult.

Thus, a novel method of forming a catalyst base that can grow carbon nanotubes with a uniform density is still required.

### SUMMARY OF THE INVENTION

It is therefore an object of the present invention to provide a novel method of forming a catalyst base.

It is a further object of the present invention to provide a novel method of forming a catalyst base that can control the growth density of carbon nanotubes and improve the uniformity of carbon nanotubes.

It is also an object of the present invention to provide a method of synthesizing carbon nanotubes employing the method of forming the catalyst base.

According to an aspect of the present invention, there is provided a method of forming a catalyst base, on which carbon nanotubes grow, the method including: applying a precursor paste containing a catalytic metal precursor, a solid and a vehicle on a substrate; and reducing the catalytic metal precursor of the precursor paste applied on the substrate to form catalytic metal particles.

In the method of forming a catalyst base, it is noted that the use of the precursor paste containing the solid provides many advantages. That is, by controlling the amount of the catalytic metal precursor in the precursor paste, the production density of the catalytic metal particles formed on the substrate can be easily controlled. The solid prevents the catalytic metal precursor from agglomerating to improve the processibility of the catalytic metal precursor. When using the precursor paste, since various coating methods that can easily provide an even coat on a substrate of a large area can be used, catalytic metal particles can be uniformly generated on a substrate of a large area at low costs. Further, when using the precursor paste, since various coating methods that can easily provide a patterned coat on a substrate of a large area can be used, catalytic metal particles can be easily patterned on a substrate of a large area.

According to another aspect of the present invention, there is provided a method of synthesizing carbon nanotubes, the method including: applying a precursor paste containing a catalytic metal precursor, a solid and a vehicle on a substrate; reducing the catalytic metal precursor of the precursor paste applied on substrate to form catalytic metal particles; and supplying a carbon source to the catalytic metal particles to grow carbon nanotubes on the catalytic metal particles.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is an electron microscopic photograph showing carbon nanotubes, prepared in an Example of the present invention;

FIG. 2 is an electron microscopic photograph showing other carbon nanotubes prepared in an Example of the present invention; and

FIG. 3 is an electron microscopic photograph showing carbon nanotubes prepared in a Comparative Example.

### DETAILED DESCRIPTION OF THE INVENTION

Hereinafter, a method of forming a catalyst base, on which carbon nanotubes grow, according to an embodiment of the present invention will be described in detail.

The method of forming a catalyst base includes applying a precursor paste containing a catalytic metal precursor, a solid and a vehicle on a substrate, and reducing the catalytic metal precursor of the precursor paste applied on substrate to form catalytic metal particles.

The precursor paste contains a catalytic metal precursor, a solid and a vehicle. The catalytic metal precursor is a metal-containing compound that can be converted into metal particles through reduction. The vehicle is a liquid material that can dissolve or disperse the catalytic metal precursor.

The solid prevents catalysts from agglomerating when forming a catalyst, and thus can easily control the growth density of the catalytic metal particles formed on a substrate. Examples of the solid include inorganic binders such as glass powder, frit, SiO₂, Al₂O₃, TiO₂, and the like. The particle size of the inorganic binder may be from several μm to tens μm. An appropriate amount of the solid can be easily selected by those skilled in the art according to specific application purposes, and thus is not limited herein. Typically, the amount of the solid in the precursor paste may be about 100 to 10,000 parts by weight based on 100 parts by weight of the catalytic metal precursor.

Examples of the catalytic metal precursor include organo-metallic compounds. The organo-metallic compound can contain at least one metal selected from the group consisting of Fe, Co, Ni, Y, Mo, Cu, Pt, V, and Ti. Examples of the organo-metallic compound include iron acetate, iron oxalate, cobalt acetate, nickel acetate, ferrocene, or a mixture thereof.

Examples of the vehicle include ethanol, ethylene glycol, terpinol, polyethylene glycol, poly vinyl alcohol, and a mixture thereof. The vehicle that can be easily removed when reducing the catalytic metal precursor is more preferred.

The compositional ratio of the precursor paste affects the production density of the catalytic metal particles. As the amount of the catalytic metal precursor in the precursor paste is decreased, the production density of the catalytic metal particles decreases. On the contrary, as the amount of the catalytic metal precursor in the precursor paste is increased, the production density of the catalytic metal particles increases.

The compositional ratio of the precursor paste also affects a viscosity of the precursor paste. The viscosity of the precursor paste should be sufficient to be applied to a desired coating method. As the amount of the vehicle in the precursor paste is decreased, the viscosity of the precursor paste increases. On the contrary, as the amount of the vehicle in the precursor paste is increased, the viscosity of the precursor paste decreases.

An appropriate compositional ratio of the precursor paste can be easily selected by those skilled in the art according to specific application purposes, and thus is not limited herein. Typically, the amount of the vehicle in the precursor paste may be about 200 to 100,000 parts by weight based on 100 parts by weight of the catalytic metal precursor. In this case, the catalytic metal precursor may be about 0.1 to 50% by weight of the total of the precursor paste.

The precursor paste can further contain a thickener. The thickener can be added to individually control the amount of the catalytic metal precursor and the viscosity of the precursor paste. Examples of the thickener include organobentonite, hydrooxyethylcellulose, ethylcellulose, and the like. The thickener that can be easily removed when reducing the catalytic metal precursor is more preferred. An appropriate amount of the thickener can be easily selected by those skilled in the art according to specific application purposes, and thus is not limited herein. Typically, the amount of the thickener in the precursor paste may be about 10-500 parts by weight based on 100 parts by weight of the catalytic metal precursor.

The precursor paste can further contain a photoresistor. The photoresistor can be added to easily form a pattern of the precursor paste using photography. Examples of the photoresistor include diazo resin, azide resin, acrylic resin, polyamide, polyester, and the like. The photoresistor that can be easily removed when reducing the catalytic metal precursor is more preferred. An appropriate amount of the photoresistor can be easily selected by those skilled in the art according to specific application purposes, and thus, is not limited herein. Typically, the amount of the photoresistor in the precursor paste may be about 100 to 1,000 parts by weight based on 100 parts by weight of the catalytic metal precursor.

The precursor paste can further contain a binder. The binder can be added to more firmly attach the precursor paste to the substrate. Examples of the binder include cellulose-based compounds, such as ethyl cellulose and nitro cellulose, and organic binders, such as acryl based resins. The binder that can be easily removed when reducing the catalytic metal precursor is more preferred. The binder may be an inorganic binder. The inorganic binder may be remained in the catalyst base after reducing the catalytic metal precursor. Examples of the inorganic binder include glass powder, frit, SiO₂, Al₂O₃, TiO₂, and the like. The particle size of the inorganic binder may be from several μm to tens μm. An appropriate amount of the binder can be easily selected by those skilled in the art according to specific application purposes, and thus, is not limited herein. Typically, the amount of the binder in the precursor paste may be about 100 to 10,000 parts by weight based on 100 parts by weight of the catalytic metal precursor.

The precursor paste can be applied on the substrate by various coating methods such as spin coating, screen printing, dip coating, blade coating, and the like. The precursor paste can be applied to the entire surface or to only a part of the surface of the substrate.

The substrate is any material to which catalytic metal particles can be attached, for example, metals with high melting points, such as Mo, Cr and W, silicon, glass, plastic, quartz, and the like. The substrate may be a flat plate or have a complex design such as a rear substrate of a field emission display (FED), in which a well for installing an emitter is formed.

Subsequently, the catalytic metal precursor of the precursor paste applied to the substrate is reduced to catalytic metal particles. During this process, the vehicle and/or other additives of the precursor paste are removed. The reduction of the catalytic metal precursor to catalytic metal particles can be performed as follows. First, the catalytic metal precursor is heat-treated under an oxidation atmosphere so as to be converted into oxide. Under a reduction atmosphere, the oxide is heat-treated or plasma-treated to be reduced to a metal. The reduction of the catalytic metal precursor can be performed by various methods known in the art.

The reduction of the catalytic metal precursor of the precursor paste applied to the surface of the substrate to catalytic metal particles can also be performed as follows. First, the precursor paste on the substrate is heated to the temperature sufficient to evaporate the vehicle, thereby removing the vehicle from the precursor paste. Then, the precursor paste having no vehicle is heat-treated under an oxidation atmosphere to remove, if any, other additives and convert the catalytic metal precursor into an oxide. Thereafter, the oxide is heat-treated or plasma-treated under a reduction atmosphere to be reduced to metal particles.

According to another embodiment of the present invention, a patterned catalyst base can be formed. For this, various printing methods, such as ink-jet printing, screen printing, etc., can be used to apply the precursor paste on the substrate.

A method of manufacturing carbon nanotubes according to an embodiment of the present invention will now be described in more detail.

The method of manufacturing carbon nanotubes includes applying a precursor paste containing a catalytic metal precursor, a solid and a vehicle on a substrate, reducing the catalytic metal precursor of the precursor paste applied on substrate to form catalytic metal particles, and supplying a carbon source to the catalytic metal particles to grow carbon nanotubes on the catalytic metal particles.

The forming of the catalytic metal particles on the substrate is performed in the same manner as previously described in the method of forming a catalyst base.

The process of growing carbon nanotubes on the catalytic metal particles by supplying the carbon source to catalytic metal particles can be performed by various methods for the manufacture of carbon nanotubes.

For example, the process of growing carbon nanotubes includes placing the substrate having catalytic metal particles, on which carbon nanotubes grow, attached thereto in a reaction chamber, supplying carbon precursor gas into the reaction chamber, and growing carbon nanotubes on the catalytic metal particles by decomposing the carbon precursor gas in the reaction chamber to supply carbon to the catalytic metal particles.

The process of growing the carbon nanotubes can be performed by low pressure chemical vapor deposition, thermal chemical vapor deposition, PECVD, or a combination thereof.

Examples of the carbon precursor gas include carbon containing compounds such as acetylene, methane, propane, ethylene, carbon monoxide, carbon dioxide, alcohol, and benzene.

If the internal temperature of the reaction chamber is too low, the crystallinity of the generated carbon nanotubes may be diminished. If the internal temperature of the reaction chamber is too high, the carbon nanotubes may not be formed. In view of this, the internal temperature of the reaction chamber may typically be in the range of about 450 to 1100° C.

Other conditions in the process of growing carbon nanotubes may typically be those suitable for the growth of carbon nanotubes and be easily selected by those skilled in the art according to specific application purposes.

In a method of manufacturing carbon nanotubes according to another embodiment of the present invention, a patterned catalyst base can be used to form a patterned carbon nanotube on a substrate. For this, various printing methods, such as ink-jet printing, screen printing and spin coating, can be used to apply the precursor paste on the substrate.

In a method of manufacturing carbon nanotubes according to still another embodiment of the present invention, a precursor paste further containing a photoresistor can be used to form a patterned carbon nanotube on a substrate. In the present embodiment, the applying of the precursor paste on the substrate includes: applying a precursor paste containing a catalytic metal precursor, a solid, a vehicle and a photoresistor on a substrate; drying the precursor paste by heating the precursor paste to remove the vehicle; exposing the dried precursor paste to a predetermined pattern; and removing a portion of the precursor paste without being patterned.

In the present embodiment, the exposing of the precursor paste and the removing of the portion of the precursor paste without being patterned can be performed using various patterning methods widely used in photolithography. For example, a precursor paste containing a photoresistor is applied on a substrate by spin coating, and then ultra violet rays are irradiated onto a region of the substrate except for a desired pattern using a photomask. Then, the substrate is developed with a developer. Wherein, the ultra violet rays with a wavelength of 400 nm or less are used and the residue, which may be remained after development, can be removed by additional plasma etching, etc.

The present embodiment, which can form a patterned carbon nanotube on the substrate, can be usefully applied to, for example, a step of forming a CNT emitter in a process of manufacturing FED.

### EXAMPLE

0.5 g of iron acetate, 0.1 g of frit, and 9.4 g of terpinol were mixed in a 3-roll mill for 10 minutes to prepare a precursor paste.

The obtained precursor paste was screen printed on a glass substrate.

The substrate having the precursor paste applied thereon was heated at 90° C. for 15 minutes to remove terpinol used as a vehicle from the screen printed precursor paste.

The precursor paste having no vehicle was heat-treated at 170° C. for 10 minutes, at 350° C. for 10 minutes, and at 450° C. for 10 minutes in an air to form a catalyst base on the substrate.

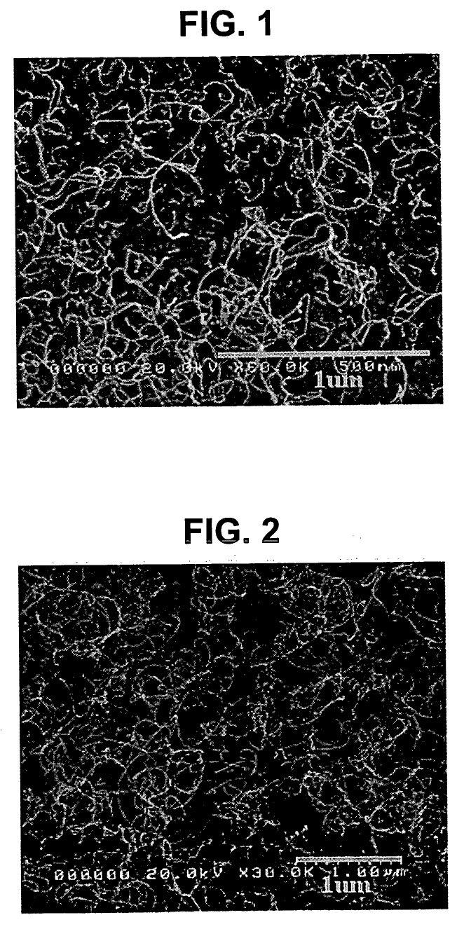

Carbon nanotubes were grown on the substrate having the catalyst base attached thereto using thermal chemical vapor deposition. A mixed gas of CO and H₂ was used as a carbon precursor gas (at this time, the catalytic metal was reduced to form the catalytic metal particles at elevated temperatures under a hydrogen atmosphere). An electron microscopic photograph of carbon nanotubes grown in the CVD chamber at 550° C. is shown in FIG. 1. An electron microscopic photograph of carbon nanotubes grown in the CVD chamber at 650° C. is shown in FIG. 2.

### COMPARATIVE EXAMPLE

A catalyst base was formed by depositing an invar (an alloy of Fe, Ni and Co) catalyst on a glass substrate at a thickness of 10 nm using an electron beam evaporator.

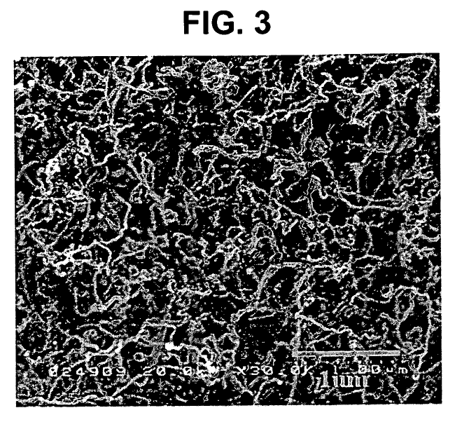

Carbon nanotubes were grown on the substrate having the catalyst base attached thereto using thermal chemical vapor deposition. A mixed gas of CO and H₂ was used as a carbon precursor gas. An electron microscopic photograph of carbon nanotubes grown in the CVD chamber at 550° C. is shown in FIG. 3.

Comparing FIGS. 1 and 2 for the Example of the present invention with FIG. 3 for the Comparative Example, it is apparent that the method of forming a catalyst base and the method of manufacturing carbon nanotubes according to embodiments of the present invention exert very improved effects.

Referring to FIG. 3, the carbon nanotubes of the Comparative Example aggregate too densely. The diameter of the carbon nanotubes of the Comparative Example is within a range of 20 to 70 nm and the uniformity thereof is poor.

Referring to FIGS. 1 and 2, the carbon nanotubes of the Example of the present invention do not aggregate densely, which indicates that the method of the present invention can easily control the growth density of the carbon nanotubes. The diameter of the carbon nanotubes shown in FIG. 1 is within a range of 10 to 20 nm and the diameter of the carbon nanotubes shown in FIG. 2 is within a range of 20 to 30 nm, indicating that the method of the present invention can grow carbon nanotubes having smaller and uniform diameters.

Thus, it is apparent that according to the method of forming a catalyst base of an embodiment of the present invention, the production density of the catalytic metal particles formed on a substrate can be easily controlled and the catalytic metal particles can be uniformly generated on the substrate.

In the method of forming a catalyst base of an embodiment of the present invention, the production density of the catalytic metal particles formed on a substrate can be easily controlled by controlling the amounts of a catalytic metal precursor and a solid in a precursor paste to prevent aggregation of catalysts. When using the precursor paste, since various coating methods that can easily provide an even coating on a substrate of a large area can be used, catalytic metal particles can be uniformly generated on a substrate of a large area at low costs. Further, when using the precursor paste, since various coating methods that can easily provide a patterned coating on a substrate of a large area can be used, a patterned catalytic metal particle can be easily produced on the substrate of a large area.

Consequently, according to the method of manufacturing carbon nanotubes of an embodiment of the present invention, the growth density of carbon nanotubes can be easily controlled and carbon nanotubes with smaller and uniform diameters can be formed. A patterned carbon nanotube can be easily formed on the substrate. Moreover, the method of manufacturing carbon nanotubes can also be easily applied to a substrate of a large area.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of forming a catalyst base, the method comprising:
applying a precursor paste containing a catalytic metal precursor, a solid and a vehicle on a substrate; and
reducing the catalytic metal precursor of the precursor paste applied on the substrate to form catalytic metal particles.

2. The method of claim 1, wherein the catalytic metal precursor is an organo-metallic compound containing at least one metal selected from the group consisting of Fe, Co, Ni, Y, Mo, Cu, Pt, V, and Ti.

3. The method of claim 1, wherein the vehicle is ethanol, ethylene glycol, terpinol, polyethylene glycol, poly vinyl alcohol, or a mixture thereof.

4. The method of claim 1, wherein an amount of the solid is about 100 to 10,000 parts by weight based on 100 parts by weight of the catalytic metal precursor, and an amount of the vehicle is about 200 to 100,000 parts by weight based on 100 parts by weight of the catalytic metal precursor.

5. The method of claim 1, wherein the precursor paste further contains a thickener, a photoresistor, a binder or a mixture thereof.

6. The method of claim 5, wherein an amount of the thickener is about 10 to 500 parts by weight based on 100 parts by weight of the catalytic metal precursor, an amount of the photoresistor is about 10 to 1,000 parts by weight based on 100 parts by weight of the catalytic metal precursor, and an amount of the binder is about 100 to 10,000 parts by weight based on 100 parts by weight of the catalytic metal precursor.

7. The method of claim 1, wherein the precursor paste is applied on the substrate by spin coating, screen printing, dip coating, blade coating or ink-jet printing.

8. The method of claim 1, wherein the reducing of the catalytic metal precursor comprises:
removing the vehicle from the precursor paste by heating the precursor paste to evaporate the vehicle;
heat-treating the precursor paste having no vehicle under an oxidation atmosphere to convert the catalytic metal precursor into oxide; and
reducing the oxide to the catalytic metal particles.

9. The method of claim 1, wherein the applying of the precursor paste on the substrate comprises:
applying the precursor paste on the substrate, the precursor paste comprises the catalytic metal precursor, the solid, the vehicle, and a photoresistor;
drying the precursor paste by heating the precursor paste to remove the vehicle;
exposing the dried precursor paste to light with a predetermined pattern; and
removing a portion of the precursor paste without being patterned.

10. A method of manufacturing carbon nanotubes, the method comprising:
applying a precursor paste containing a catalytic metal precursor, a solid and a vehicle on a substrate;
reducing the catalytic metal precursor of the precursor paste applied on substrate to form catalytic metal particles; and
supplying a carbon source to the catalytic metal particles to grow carbon nanotubes on the catalytic metal particles.

11. The method of claim 10, wherein the catalytic metal precursor is an organo-metallic compound containing at least one metal selected from the group consisting of Fe, Co, Ni, Y, Mo, Cu, Pt, V, and Ti.

12. The method of claim 10, wherein the vehicle is ethanol, ethylene glycol, terpinol, polyethylene glycol, poly vinyl alcohol, or a mixture thereof.

13. The method of claim 10, wherein an amount of the solid is about 100 to 10,000 parts by weight based on 100 parts by weight of the catalytic metal precursor, and an amount of the vehicle is about 200 to 100,000 parts by weight based on 100 parts by weight of the catalytic metal precursor.

14. The method of claim 10, wherein the precursor paste further contains a thickener, a photoresistor, a binder or a mixture thereof.

15. The method of claim 10, wherein the precursor paste is applied on the substrate by spin coating, screen printing, dip coating, blade coating or ink-jet printing.

16. The method of claim 10, wherein the reducing of the catalytic metal precursor comprises:
removing the vehicle from the precursor paste by heating the precursor paste on the substrate to evaporate the vehicle;
heat-treating the precursor paste having no vehicle under an oxidation atmosphere to convert the catalytic metal precursor into oxide; and
reducing the oxide to the catalytic metal particles.

17. The method of claim 10, wherein the applying of the precursor paste on the substrate comprises:
applying the precursor paste containing the catalytic metal precursor, the solid, the vehicle and a photoresistor on a substrate;
drying the precursor paste by heating the precursor paste to remove the vehicle;
exposing the dried precursor paste to light with a predetermined pattern; and
removing a portion of the precursor paste without being patterned.

18. The method of claim 10, wherein the growing of the carbon nanotubes is performed by chemical vapor deposition.

19. Carbon nanotubes manufactured by claim 10.

20. A method of manufacturing carbon nanotubes, the method comprising:
applying a precursor paste on a substrate, the precursor paste comprising a catalytic metal precursor containing an organo-metallic compound, about 100 to 10,000 parts by weight of a solid based on 100 parts by weight of the catalytic metal precursor, and about 200 to 100,000 parts by weight of a vehicle based on 100 parts by weight of the catalytic metal precursor, the organo-metallic compound containing at least one metal selected from the group consisting of Fe, Co, Ni, Y, Mo, Cu, Pt, V, and Ti, the vehicle selected from the group consisting of ethanol, ethylene glycol, terpinol, polyethylene glycol, poly vinyl alcohol, and a mixture thereof, the solid selected from the group consisting of glass powder, frit, SiO₂, Al₂O₃, and TiO₂; and
reducing the catalytic metal precursor of the precursor paste applied on the substrate to form catalytic metal particles.
